(19) United States
(12) Patent Application Publication
(10) Pub. No.: US 2015/0065645 A1
(43) Pub. Date: Mar. 5, 2015

(54) HUDS COLORANTS FOR PAINTS, DYES, AND INKS

(71) Applicants: Ruth Ann Mullen, Bellevue, WA (US); Christopher Somogyi, Holualoa, HA (US)

(72) Inventors: Ruth Ann Mullen, Bellevue, WA (US); Christopher Somogyi, Holualoa, HA (US)

(21) Appl. No.: 14/468,439

(22) Filed: Aug. 26, 2014

Related U.S. Application Data
(60) Provisional application No. 61/871,165, filed on Aug. 28, 2013.

(51) Int. Cl. C09D 135/02

(52) U.S. Cl. CPC C09D 135/02; C08K 3/36
USPC 524/559

(57) ABSTRACT

Hyperuniformly disordered structures (HUDS) as colorants for use in paints, dyes, and methods for manufacturing the same. Applications of HUDS made via the processes and methods described herein include almost any application involving light, from photovoltaics and light emitters to optical sensors, optical communications devices, optical filters, distance-measuring, tracking, and other applications. The techniques may also be applied to selectively reflect colors outside the visible spectrum, including infra-red or ultra-violet wavelengths.

### CROSS REFERENCE TO RELATED APPLICATIONS

This application claims the benefit of the filing date of U.S. Provisional Application No. 61/871,165 filed Aug. 28, 2013, entitled “HUDS COLORANTS FOR PAINTS, DYES, AND INKS” under 35 U.S.C. §119(e), which is incorporated by reference in its entirety for all purposes.

### INCORPORATION BY REFERENCE OF PUBLISHED PATENT APPLICATIONS

This application includes subject matter relating to subject matter disclosed in U.S. Publication No. 2012/0138864, entitled “NON-CRYSTALLINE MATERIALS HAVING COMPLETE PHOTONIC, ELECTRONIC, OR PHONONIC BAND GAPS,” and U.S. Application Serial No. PCT/US2012/055791 “NARROW-BAND FREQUENCY FILTERS AND SPLITTERS, PHOTONIC SENSORS, AND CAVITIES HAVING PRE-SELECTED CAVITY MODES,” (published as WO 2013055503 A1) both of which are incorporated by reference in their entireties for all purposes.

### FIELD OF THE INVENTION

The field of invention relates generally to colorants used for paints, dyes, and inks and, more specifically but not exclusively relates to use of hyperuniformly disordered structures HUDS in colorants.

### BACKGROUND INFORMATION

This invention relates to paints, dyes, inks, coating, filters, and other products such as colored plastics, the optical reflectance, transmittance, and absorbance of which is controlled by design. Paints, inks, and dyes, herein referred to collectively as “paints,” add value to products, for example, by making them more attractive, longer-lasting (or perhaps in some cases, shorter-lasting), easier to clean, securely identifiable, camouflaged, wavelength-converting, reflective, and/or light-blocking. While pigments are traditionally used to add color to paints, pigments can disadvantageously be expensive, toxic, and prone to chemical degradation.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a white light photograph of a series of two-dimensional (2D) finite height HUDS fabricated in the same 220 nm thick silicon-on-insulator material system as is used for making computer processors, with the series from left to right showing how when the same structure shapes are scaled to increasingly small dimensions, the structural color of the sample changes from grey to black to red and across the electromagnetic spectrum to blue-green;

FIG. 2 is a scanning electron microscope (SEM) photograph of a 2D finite height HUDS fabricated in the same 220 nm thick silicon-on-insulator material system as in FIG. 1, scaled to have a photonic band gap centered at a wavelength in the vicinity of 1.55 microns;

FIG. 3 is a Scanning Electron Microscope (SEM) photograph of a 3D structure having substantial topological similarities to hyperuniformly disordered structures and scaled to have a photonic band gap corresponding to a wavelength of approximately 3 microns;

FIG. 4 is a diagram illustrating a suspension of spherical HUDS micro-particles; and

FIG. 5 is a diagram illustrating geometric light scattering from spherical particles about 10× larger than an optical wavelength.

### DETAILED DESCRIPTION

Embodiments of structures and techniques for manufacturing hyperuniformly disordered structures (HUDS), HUDS-based coatings, HUDS colorants, and the use of HUDS colorants in paints, inks, and dyes are described herein. In the following description, numerous specific details are set forth to provide a thorough understanding of embodiments disclosed and illustrated herein. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The embodiments described herein include embodiments relating to novel methods for imparting color to paints. The techniques may also be applied to selectively reflect colors outside the visible spectrum, including infra-red or ultra-violet wavelengths.

Applications of HUDS made via the processes and methods described herein include almost any application involving light, from photovoltaics and light emitters to optical sensors, optical communications devices, optical filters, distance-measuring, tracking, and other applications.

Advantages compared to paints and coatings comprising photonic crystals include that the isotropy of HUDS makes its structural color appear the same from all angles of illumination and all viewing angles. As well, with HUDS, one can additionally engineer additional isotropic optical properties beyond spectral reflectance, spectral transmittance, and scattering, to include group velocity inside the structure, group velocity dispersion as a function of wavelength, Q-factors for light trapping at defects, absorption depth associated with absorbers in the structure, etc.

Another advantage of HUDS-based paints and coatings will be that their surface structure can provide anti-fouling properties, analogous to effects seen in nature on flower petals, which repel dirt.

Applications extend across the optical spectrum into the THz range. The electromagnetic frequencies at which embodiments of the invention most sensitively affects the propagation of light is determined by factors which include for the dimensions of the comprising sub-optical elements of the HUDS structure, and the indices of refraction of the two materials out of which the HUDS structure is made. As well, in the case that HUDS is divided into micro-particles, the size and shape of the micro-particle will affect the propagation of light on transmission, reflection and scattering.

Another class of products which can be made by the disclosed technique include paints, dyes, inks including inks for inkjet printers and laser printers, colored plastics for 3D printers, colored optical filters, and other products, the optical reflectance, transmittance, and absorbance of which is controlled by geometric and physical design and by the index of refraction of the materials out of which they are made rather than exclusively by pigment. Paints, inks, and dyes, herein referred to collectively as “paints,” add value to products, for example, by making them more attractive, longer-lasting (or perhaps in some cases, shorter-lasting, for example in cases where one might want to purposefully shorten the lifetime of a paint in order to correlate, for example, with an expiration date on the product), easier to clean, securely identifiable, camouflaged, wavelength-converting, reflective, and/or light-blocking.

To the extent that which the teachings and principles of the embodiments disclosed herein are implemented in a final process that is tunable, the optical properties of the final product will be dynamically controllable.

Examples of processes the dynamic control of which will affect the optical properties of the final product include temperature, pressure, time, the presence or absence of specially-patterned templates, mechanical forces such as jiggling or shear, acoustic forces including ultrasonic forces, optical forces such as those used for optical tweezers, and magnetic forces.

The principles and teachings herein also relate to methods for making designer dielectric materials the electromagnetic reflectance and transmittance of which can be isotropic; the structures which can be made with these methods; and their applications. The scale of the structural designs is on the order of a half a wavelength. The invention provides an improvement on periodic designer dielectrics formed from emulsion processes in that it can provide photonic band gaps which are angularly isotropic.

The structural colors of materials manufactured using the techniques disclosed herein can be used to increase the value of a product by providing it with attractive, informative, or otherwise value-adding patterns. For example, both a single color and color variations can be used to identify the product as having a particular brand. The structural colors may also be used, for example, to impart color to a product during or after manufacturing.

HUDS-based colorants advantageously obviate the need to stockpile or otherwise keep on-hand either different pigments or mechanically-made brand identifications such as emblems which might otherwise need to be glued, sewn, or otherwise mechanically attached to the product. For example, the structural colors can be used on an automobile to identify it with its brand name and model number, without having to either keep a separate pigment on-hand in the paint shop, or bolt or otherwise attach a mechanically-constructed name brand or model number to the product. Shoes, handbags, communications devices, perfume containers, food products, or other consumer or industrial object can similarly be brand-identified without having to keep separate pigments or emblems on-hand.

The colors can, as well, be used to label products with optical tags such as colored bar codes capable of identifying model number, serial number, and other relevant identifiers as required to facilitate inventory control, logistics, just-in-time manufacturing, the systematic or deterministic formation of interconnects in data centers, and other business processes having high economic value. The use of color in such bar codes advantageously enables them to store more information per unit area than is possible with black and white bar codes. Both one and two-dimensional bar codes are possible with one and two-dimensional arrangements of color. Three-dimensional bar codes are also possible.

In one embodiment of the invention, a coating is comprised entirely of a single HUDS. In another embodiment, the coating comprises a continuous or a near-continuous packing of separate HUDS particles, analogously perhaps to how multi-crystalline silicon is a densely-packed arrangement of single crystal silicon particles. In another embodiment of the invention, small particles of HUDS material are divided into HUDS micro-particles and dispersed or suspended into a binder.

The present invention also relates to a new method of imparting color to material as it is being made, enabling elimination of the need to keep pigments and dyes stockpiled or otherwise on-hand. This is because the color, which can optionally be either angularly isotropic or iridescent, is a function of process control rather than of a chemical pigment. In one embodiment of this invention, an operator of a piece of equipment can switch not only between the creation of different colors upon change of operating conditions, but also between creation of isotropic and iridescent colors upon change of operating conditions.

Applications of these coatings include solar energy systems in which the HUDS can be used to advantage for spectral splitting, light-trapping, and spectral shifting; coloration and/or protection of vehicles such as automobiles, motorcycles, bicycles, ships and boats; coloration of fabrics for use in window treatments, clothing, furniture, sails, tents, bedding, and other applications, where an advantage of this approach may include breathability; cosmetics including nail polish, lip stick, lip gloss, eye make-up, face paint, and body paint; consumer electronics including smartphones, smartwatches, and head-mounted personal internet interfaces; books, greeting cards, posters, signs, and other printed matter; paint for homes and buildings, both interior and exterior; paint for works of art; kitchen products such as dishes and pots and pans (where an advantage includes the possibility of getting a brilliant blue color without having to use lead, as well as a potential advantage that food might not stick to it because of the irregularities on the surface); jewelry; other consumer products such as toys, memorabilia, etc., including distinctive identification of specific products so as to distinctively identify a branded product as required to capture its brand-related value. Additional applications include fixed or dynamically tunable optical filters for cameras or displays, large aperture filters for free space links capable, for example, of cutting off other bright light sources such as the sun, the moon, a glint from a building, or an optical countermeasure in communications, targeting, or tracking applications; windows, lampshades, blinds, curtains, and shower-glass; sunscreens; and uv-protected plastic components for all applications where these components may be exposed to sunlight

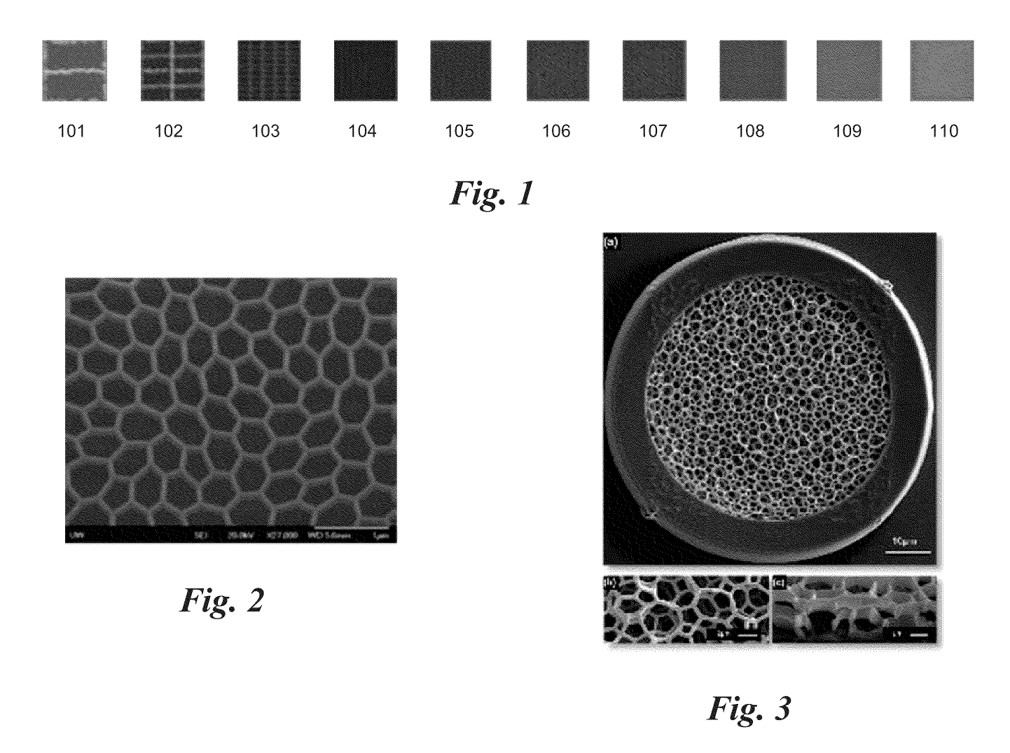

Photographs of 2D finite height HUDS fabricated in 220 nm high silicon-on-insulator are displayed in FIGS. 1 and 2. Both of these Figures are of structures made via the ebeam lithography and reactive ion etching techniques. FIG. 1 is a top-view photograph of a series of identically-shaped layouts, scaled to increasingly small dimensions from left to right. Viewed with a white light microscope, sample 101 with its ˜5.6 micron average cell diameter appears to have the same grey color typical of bulk silicon. Samples 102, 103, and 104 with average cell diameters of 2.8, 1.1, and 0.56 microns respectively, are increasingly darker shades of grey. Sample 105 with average cell size of 467 nm is red. Sample 106 with average cell size ˜431 nm is an orangy red. Sample 107 with average cell size ˜400 nm is reddish-orange. Sample 108 with average cell size of 329 nm is orange. Sample 109 with average cell size of 280 nm is yellowish-green. Sample 110 with average cell size of ˜233 nm is bluish-green. The apparent colors under white light illumination can be understood by understanding that the average cell size is approximately half the wavelength of the photonic band gap, appropriately adjusted by the dielectric constant of the silicon in accordance with the fill ratio of the structure.

FIG. 2 (Nahal, Man, Florescu, Steinhardt, Torquato, Chaikin, and Mullen, “New Designer Dielectric Metamaterial with Isotropic Photonic Band Gap,” IEEE International Photonics Conference, Bellevue, Wash. September 2013) is a scanning electron microscope photograph of a sample made by the same technique as was used to make the samples in FIG. 1. For higher-throughput lithographic fabrication techniques appropriate to the massively parallel fabrication of 2D finite height HUDS, two approaches include optical lithography and nano-contact printing. Other known approaches may also be used.

Two-photon lithography has also been used to make complex 3D meso-structures having substantial topological similarity to HUDS (Haberko and Scheffold, “Silicon Hyperuniform Disordered Photonic Materials with a Pronounced Gap in the Shortwave Infrared” Adv. Optical Mater., doi: 10.1002/adom.201300415, 2013) have recently been demonstrated to exhibit photonic band gaps in the range for which they were originally sized, corresponding to optical wavelengths of about 3 microns (Muller, Haberko Marichy, and Scheffold, “Fabrication of mesoscale polymeric templates for three-dimensional disordered photonic materials,” Optics Express, 21, 1057, 2013) have been as shown in FIG. 3.

For example, an experimentally proven method for making three-dimensional disordered structures at micron-scale and sub-micron-scale dimensions and was described by Haberko and Scheffold, “Fabrication of mesoscale polymeric templates for three-dimensional disordered photonic materials,” Optics Express, 21, 1057, 2013.

The formation of an isotropic photonic band gap in a hyperuniform disordered solid (HUDS) requires appropriate choice of material, average lattice spacing, and fill ratio (Florescu, Torquato and Steinhardt, Designer Florescu 2009). Material choice is driven in large part by the fact that the larger the index of refraction of the material relative to air, the larger the photonic band gaps that will be possible. The choice of fill ratio is driven by the fact that smaller fill ratios can lead to larger band gaps. The fill ratio and the relative index of refraction both have an effect on how large a photonic band gap can be achieved. The average lattice spacing, appropriately scaled by the effective dielectric constant of the HUDS, affects the center frequency of the photonic band gap. That said, while most HUDS are likely to be formed from a solid material and air, it is also possible to form HUDS from two or more solid materials as well as from a solid material and a fluid other than air. The use of vacuum in lieu of air advantageously further increases the relative dielectric constant of the two components out of which HUDS is fabricated.

### Methods of Making HUDS Particularly Appropriate to High-Volume Manufacturing

A method for scaling the above-described lithographic approaches to higher-volume manufacturing is nano-contact printing. In this process, lithographic processes are used to make a stamp or screen (analogous to the screens used in a silk-screen process). An example of the use of nano-contact printing to make photonic crystals is described for example in Kaplan, Omenetto, Lawrence, Cronin-Golomb, Georgakoudi, and Dal Negro, “Fabrication of Silk Fibroin Photonic Structures by Nanocontact Imprinting,” U.S. Publication No. 2012/0121820, U.S. application Ser. No. 12/741,066, filed Nov. 5, 2008 (incorporated by reference in its entirety herein for all purposes) can be readily-adapted to the nanocontact printing of HUDS structures by starting with a HUDS template.

A method appropriate to higher-volume manufacturing of 3D HUDS is to use Photocurable resins such as ETPTA (n=1.4689) as a vehicle for silica particles (n=1.45). Without the shear forces known to effect “crystallization” of this system, the silica particles can be configured for maximally random jamming (MRJ) and/or other hyperuniformly disordered arrangements. This system can be uv-cured. The position of the stop band can be controlled by changing the particle diameter and volume fraction.

Alternate materials can be used for the resin, including alternate materials such as materials having higher index of refraction. As well, materials such as titanium dioxide or other materials having higher index of refraction than the resin can be used in lieu of the silica, and the resin can be removed either by baking or dissolution. As well, comprising materials such as silica can be treated to remove oxygen, leaving behind a material with a high index of refraction approaching or equal to that of silicon (or another high index material). As well, inverse-opal processes described for example by Klimonsky, Abramova, Sinitskii and Tretyakov, “Photonic crystals based on opals and inverse opals: synthesis and structural features,” Russ. Chem. Rev. 80 1191. doi:10.1070/RC2011v080n12ABEH004237, Received 22 Jun. 2011 and Fudozi and Xia, “Colloidal Crystals with Tunable Colors and Their Use as Photonic Papers,” Langmuir, 19 (23), 9653-9660, 2003, can be performed on these systems so as to create an inverted structure made out of yet another material.

In another embodiment, the present invention discloses an emulsion-based approach designed to self-assemble the nanostructure.

One way to make the emulsion is to blend oil-based and water-based liquids together. Such blends, typically featuring a wide distribution of constituent droplet sizes, have been used to test theoretical predictions regarding the effects of Mie scattering on the propagation of light through inhomogeneous and turbid media (R. Michels, F. Foschum and A. Kienle, “Optical properties of fat emulsions,” Optics Express, vol. 16, no. 8, pp. 5907-5925, 2008).

Using techniques well-known in the art including fractionation (J. Bibette, “Depletion interactions and fractionated crystallization for polydisperse emulsion purification,” J. Colloid. Interface Sci., vol. 147, pp. 474-478, 1991) (A. Imhof and D. J. Pine, “Ordered macroporous materials by emulsion templating,” Nature, vol. 389, pp. 948-951, 30 Oct. 1997) (A. Imhof and D. Pine, “Stability of Nonaqueous Emulsions,” Journal of Colloid and Interface Science, vol. 192, pp. 368-374, 1997), the size of the oil droplets in such oil-and-water blends can be both tightly-controlled and made mono-disperse.

Further flexibility in the formation of these droplets accrues from recent engineering advances involving applications of droplet microfluidics to advanced materials (Seeman, M. Brinkmann, T. Pfohl and S. Herminghaus, “Droplet based microfluidics,” Reports on Progress in Physics, pp. 016601-016642, 2012), enabling exquisitely precise control of droplet sorting, mixing, and coalescence that was not possible prior to the application of modern microfluidics techniques for the formation of droplet-derived photonic band gap structures.

Another known way to control the diameter of emulsion droplets is by choice of the inner diameter of a micropipette and the velocity of a co-flowing stream, as was demonstrated, for example, in Kim, Lee, Yi, Pine, and Yang, 2006; “Microwave-Assisted Self-Organization of Colloidal Particles in Confining Aqueous Droplets.” Journal of the American Chemical Society 128, 10897-10904, 2006.

These known techniques provide stability against demixing induced by droplet coalescence and against coarsening by Ostwald ripening (Imhof and Pine, Stability of Nonaqueous Emulsions 1997). The size of the droplets (and hence the photonic band gap of the final finished product) will be a controllable process parameter.

Semiconductor particles such as those prepared for ink jet printer applications by the technique described in U.S. Pat. No. 8,314,416 B2 (M. Heeney, I. McCulloch, M. Shkunov and R. Simms, “Organic semiconductor formulation” (incorporated by reference in its entirity herein for all purposes)) can be incorporated into these emulsions.

The electromagnetic frequencies at which the invention most sensitively affects the propagation of light is determined by factors which include the size of comprising droplets that can be controllably created and suspended in an appropriate emulsion, the fidelity with which these suspensions can be either directly or inversely converted into the desired final material, and the fill ratios achievable in the final structure.

Known methods for configuring the droplets into periodic configurations such as crystalline configurations include shear-induced crystallization known to occur for example when pressing droplets between two plates. For example, see Kim, Cho, Jeon, Eun, Yi, and Yang. “Templating” Advanced Materials 20, 3268-3273, 2008; and Lee, Shim, Hwang, Yang, and Kim. “Colloidal Photonic Crystals toward Structural Color Palettes for Security Materials.” Chemistry of Materials, 2013: 2684-2690Lee, et al. 2013. Droplet-sized polystyrene beads are known to self-assemble in a hexagonally-close-packed arrangement on the surface of water (Zhang, Chao, and Asher. “Asymmetric Free-Standing 2-D Photonic Crystal Films and Their Janus Particles.” Journal of the American Chemical Society, 2013: 11397-11401.)

The principles and teachings herein provide an easier way to form the skeletal framework for building a photonic band gap structure, namely, by starting with a configuration which is hyperuniform rather than periodic. Indeed, many early attempts to make opaline or other colloidal photonic crystals were frustrated by the difficulty of obtaining a crystalline structure. While some of these early structures may have been nearly hyperuniform, the possibility of obtaining a photonic band gap from anything but a crystalline (or later, a quasi-crystalline) structure was not appreciated until the present invention.

In accordance with one embodiment, a sufficiently mono-disperse collection of oil droplets can be configured so that the oil droplets are packed-together in the “maximally random jammed” (MRJ) configuration. As this MRJ configuration is known to be hyperuniform (Torquato, S., and F. H. Stillinger. “Local Density Fluctuations, Hyperuniform Systems, and Order Metrics.” Phys. Rev. E 68, no. 68 (2003): 1-25), it provides an appropriate skeletal framework for the formation of a hyperuniform disordered solid having a photonic band gap. One method to coax the droplets (or particles) into a hyperuniform arrangement would be repetitive annealing under appropriate levels of temperature and pressure. Another method to coax the droplets (or particles) into a hyperuniform arrangement would be to press them between solid plates made for example from a material such as glass, silicon, plastic, or metal, one or more of which is structured with a hyperuniform template. Such a template can beneficially provide for the initiation of directed self-assembly.

A specially-patterned template can be either fixed or dynamically-tunable. Examples of dynamically-tunable templates may include a micro- or nano-electromechanical surface, or a programmable optical template designed to impose hyperuniformly disordered force fields on a suspension.

Fixed or dynamically-programmable templates can also direct the self-assembly of combinations of HUDS with other structures.

A dynamically-tunable template can flexibly direct the self-assembly of structures other than HUDS, such as photonic crystals and quasicrystals, and can direct the self-assembly of combinations of HUDS with other structures such as photonic crystals and photonic quasicrystals.

As well, the droplets (or nano-spheres) could be functionalized with molecules designed to control the inter-droplet (or inter-sphere) separations. Additional methods of obtaining an MRJ configuration for the starting droplets (or spheres) will be known to those skilled in the art of soft condensed matter physics.

Adaptation of this technique to large surfaces may optionally involve the use of a squeegee-type tool to simultaneously compress and spread the emulsion at the appropriate temperature and pressure. Optionally preparing the surface on which the emulsion is spread with an appropriately-sized 2D nano-imprinted HUDS pattern may beneficially form a template for facilitating the choice of a hyperuniform distribution on the bottom layer.

In the event that a thick sample is required, annealing the system at appropriate temperatures and pressures may be preferable to the use of a squeegee or two glass plates. This is because samples substantially thicker than is required in an ink, paint, or thin film coating application, will have less sensitivity to template-imposed arrangements originating on the boundary of the sample, as compared with thinner samples.

Entire parts such as bulk filters or other optical components can be made out of HUDS via this emulsion-based process.

Once the hyperuniform skeleton is formed by the above-described emulsion process, either or both of the two elements out of which the emulsion is made can be replaced with an alternate material having appropriate dielectric constants and mechanical strengths, in what is known as an inverse opal process.

For example, in the event that the emulsion is based on oil and water, the oil might first be polymerized to form a hard plastic, after which the water is evaporated away. Alternatively, in lieu of pure water, one could use a solution of water into which a material having the appropriate dielectric properties (e.g. silicon or another chemical) has been dissolved so that once the water has been evaporated, solid silicon or silicon dioxide or another material remains as a hard lattice around the oil droplets. As a final step, the oil droplets could be drained, burnt-away, forced-out, or otherwise removed.

In another approach, one might consider using a special formulation of oil designed to leave behind a high-index material upon appropriate processing. In this case, once the oil droplets have been appropriately processed (e.g. via heat, microwave, x-ray, or other treatment) they will leave behind a hard lattice of appropriately high index material. The water could then be drained from the system or otherwise removed, for example by evaporation.

Alternate approaches known in the art for making potentially large samples of structured material of this dimension include other kinds of self-assembly including colloidal self-assembly, foam-based self-assembly, and biological self-assembly; directed self-assembly including chemical and biological self-assembly; and the adaptation of biologically-inspired approaches inspired by the structural color of shells such as mother-of-pearl, bird feathers, and other living organisms. Once a HUDS pattern is formed, methods known in the art can be used to create defects in the HUDS lattice, further modifying its optical properties. One such method involving two-photon lithography is described in Arsenault, André, et al. “Perfecting Imperfection—Designer Defects in Colloidal Photonic Crystals.” Adv. Materials 18 (2006): 2779-2785. As well, defects can purposefully be formed in the structure using any number of other methods known in the art, such as x-rays, e-beams, and other optical methods including “diffraction unlimited” methods useful for modifying structures on a scale small compared to the wavelength of light, such as are described, for example, in U.S. Publication No. 20120092632 A1, which is incorporated by reference in its entirety for all purposes.

Combinations of the above are also possible as will be evident to those skilled in the art.

A preferred method for processing the colloidal structures to make them hyperuniformly arranged is annealing, combined if possible with pressure. This method, already demonstrated to work on the atomic scale in simulations of nearly hyperuniform networks in amorphous silicon (Hejna, Steinhardt, and Torquato, “Nearly hyperuniform network models of amorphous silicon.” Phys. Rev. B 87, 245204, 2013), is adaptable to facilitate the formation of nearly hyperuniform networks of sub-wavelength spheres. While thermal heating and cooling is known to be an effective approach to annealing of atomic systems such as silicon, the annealing of large-scale systems such as nano-particles may involve mechanical vibrations.

### Suspensions of HUDS Micro-Particles Dispersed in a Binder

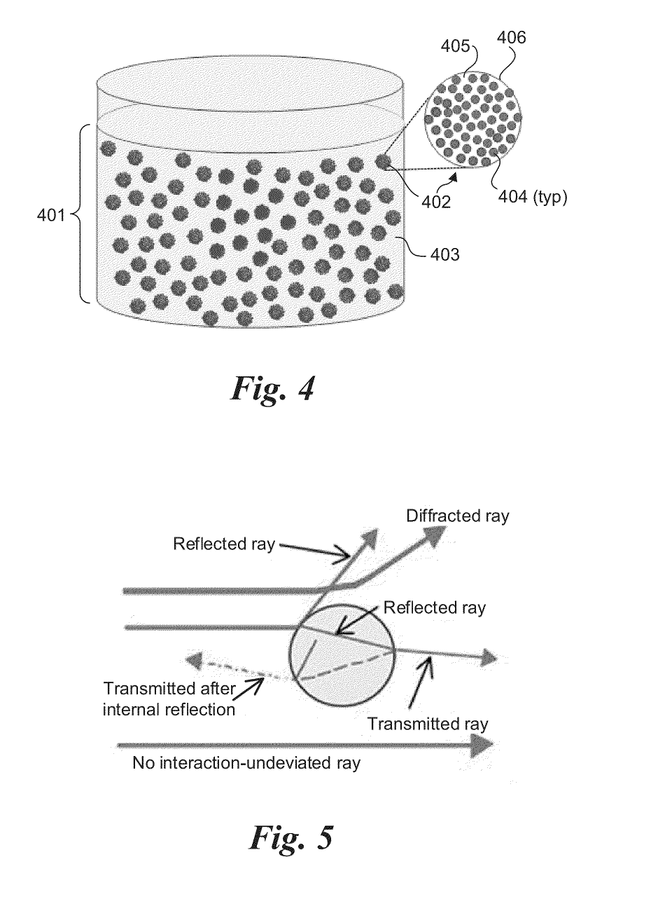

In another embodiment of the invention, Micro-particles of hyperuniformly disordered structures (HUDS), designed and fabricated to exhibit structural color, are blended, suspended or otherwise dispersed into a base material which may be a liquid binder (also known as a vehicle) such as shown in FIG. 4 or powder so as to impart to the base material a desired color. Reference number 401 is the liquid suspension of colorant HUDS micro-particles dispersed throughout a binder liquid. Reference number 402 identifies HUDS micro-particles (microspheres shown as an example). For particles >10 microns diameter, apparent color depends primarily on micro-particle's sub-micron structure, a.k.a. its nanostructure. Micro-particles can be spherical, round, flat, disk-shaped, or irregularly shaped. Micro-particles preferably comprise three-dimensional HUDS for optimal isotropy. Two-dimensional finite height HUDS micro-particles are also possible, with the understanding that the optical properties of individual 2D micro-particles will not be perfectly isotropic but will depends on the angle of light incidence and on the viewing angle, as determined as well by the angular distribution of the 2D finite height particles in suspension 401. Reference number 403 identifies the liquid binder or vehicle in which HUDS micro-particles are suspended or dispersed, with the micro-particles comprising nanoparticles 404. Each HUDS micro-particle 402 comprises a collection of nanoparticles 404 (e.g., nano-spheres shown as an example, though the particles can have different shapes) in an air or other low index matrix 405. These nanoparticles are typically sized on the order of half a wavelength of light, with all due consideration for the refractive index out of which the nanoparticle is made, and the refractive index of the material planned to fill in the spaces between the nanoparticles. While the illustrated micro-particle comprises nano-spheres separated by air voids, inverse opal and other processes described above can be used to obtain micro-spheres comprising a hyperuniformly disordered lattice such as was shown in FIG. 3. Reference number 406 identifies an optional transparent shell around the micro-particle that can beneficially seal the micro-particle, preventing it from being permeated by the binder or vehicle liquid, as might be helpful in the event that the wettability of the structure does not by itself prevent permeation of the micro-particle by the binder or vehicle liquid.

When the base material is a liquid, dispersing or otherwise blending the HUDS micro-particles in the liquid forms a paint, dye, or ink which can be used, for example, to impart color to diverse solid surfaces including wood, metal, ceramics, plastics, textiles, paper, fibers, etc. These liquids can be dried or cured by any of several methods commonly known in the art including solvent evaporation, polymerization, oxidative cross-linking, and coalescence. When the base material is a powder, electrostatic and/or heat can be used to convert the powder to a finished paint. The base liquid can also be a liquid plastic such as that used in injection-molding or 3D printers. In this case, the HUDS micro-particles impart color throughout the volume of plastic.

The HUDS paints or micro-particles can be made, for example, from an emulsion, foam, droplet, thin film, colloidal, lithographic, nano-contact printing, or other method known to create hyperuniformly-arranged structures.

The micro-particles can be either divided out of a larger HUDS structure (e.g. by cutting a HUDS film into individual flakes or solids), or made to their final size (e.g. by forming the HUDS by a droplet method appropriately adapted from known methods such as Kim et al. 2006, and Kim et al. 2008.

The reflectivity of the paint will increase with increased concentration of HUDS micro-particles. Those wavelengths above and below the photonic band gap of the HUDS will be transmitted by the HUDS micro-particles rather than reflected. As the HUDS micro-particles are large compared with the wavelength of light, scattering effects of the particles will be describable by the combination of geometric optics (Webb, Paul A. A Primer on Particle Sizing by Static Laser Light Scattering. January 2000. http://www.particletesting.com/docs/primer_particle_sizing_laser.pdf, accessed Aug. 27, 2013) with the spectral reflectance and transmittance coefficients of the HUDS micro-particles. Transmitted wavelengths will presumably be focused by micro-spheres, while reflected wavelengths will be de-focused by the convex surface of a micro-sphere. Predicting geometric scattering effects of non-spherical HUDS particles will be a complex function of the particle shapes, the distribution of shapes, and the distribution of their orientations. These geometric scattering effects will beneficially contribute toward making the paint opaque. In an otherwise transparent vehicle or binder, geometric scattering from the HUDS micro-particles will contribute toward dispersion of light over a wide area as is desirable, for example, in a lampshade or LED cover. Scattering can also advantageously provide privacy as is beneficial, for example, in a shower door. While three-dimensional HUDS are preferred for the three-dimensional isotropy of their optical properties, finite-height two-dimensional HUDS particles will have optical properties associated with their 2D optical isotropy that advantageously differ from those associated with prior art thin film flakes (e.g., see Lee, Shim, Hwang, Yang, and Kim. “Colloidal Photonic Crystals toward Structural Color Palettes for Security Materials.” Chemistry of Materials, 2684-2690, 2013, and Yang, Kim, Shim, and Yi “Pigment consisting of photonic crystals for a paint composition, and method for producing same,” Europe Patent EP2371908A2, Oct. 10, 2008); and prior art microspheres having a 2D photonic crystal shell (e.g., see Yang, Kim, Jeon, Yi, and Jeong, “Method for in-situ manufacturing monodisperse spherical photonic crystals with single or multi-colors using microfluidic devices,” Patent WO/2009/128588, 2009.), (Kim et al. 2006), (Kim et al. 2008).

The final color, color purity, brilliance, and vividness (determined, for example, by the size of the oil droplet that is used, the dispersion of the oil droplets, and their final separation in the emulsion) can be determined by process control, eliminating the need to keep differently-colored paints, dyes, inks, plastics, or other materials on-hand.

Compared to chemical pigment colorants, an advantage of HUDS-based colorants is that they will not fade, as they are structural rather than chemical. Another advantage of HUDS-based structural colorants is that they may be less toxic than some of the commonly-used pigments.

Compared to photonic crystal colorants, two advantages of HUDS-based colorants may include both the angularly-isotropic optical properties of the colorant micro-spheres, the angular isotropy of the material out of which non-spherical micro-particles are made, and potentially improved ease of manufacturing.

Finally, the precision with which both the width and central position of the photonic band gap of HUDS micro-particles can be designed provides complete color flexibility to the pigment. Either exquisitely pure or blended colors can be obtained by using either a single colorant having an appropriately narrow-band reflectance, or a mixture of colorants each of which reflects at a different band.

As the hyperuniformly-arranged particles within each HUDS micro-particle do not need to be ordered, they will be easier to make at large volume and high yield than either a photonic crystal or a photonic quasi-crystal, and will probably be less costly. In part, this ease of fabrication arises from the increased fabrication tolerance of HUDS as compared to photonic crystals or photonic quasicrystals.

HUDS Colorants for Inks, Paints, or Dyes

One class of HUDS colorants comprises Micro-particles (which importantly include both micro-spheres and micro-flakes) comprising either nano-particles (having diameter typically less than a half-wavelength of light, distributed in a hyperuniformly disordered network throughout a volume), or their inverse structures. Types of micro-particles include Designer Gap, Designer Dispersion, Designer Defects, and Designer combinations comprising combinations of Designer Gap, Designer Dispersion, and Designer Defects.

Designer Gap micro-particles have a photonic band gap of a particular frequency width and a particular central frequency. Under Designer Dispersion, the micro-particles may not necessarily have a photonic band gap, but are designed to have a particular dispersion characteristic with respect to its index of refraction n(λ).

Under Designer Defects, a HUDS-based structural colorant, with or without a photonic band gap, may be designed and fabricated with resonant defects designed to trap light of particular frequencies at “cavities” such as are described in Florescu, Steinhardt and Torquato, “Optical cavities and waveguides in hyperuniform disordered photonic solids,” Phys. Rev. B 87, 165116, 2013. By positioning very small amounts of conventional chemical pigments at or near these defect locations, the absorption coefficient associated with the use of each chemical pigment atom or molecule can be essentially enhanced. This will advantageously reduce the amount of pigment required to get the same absorption, thus both reducing the cost of pigment required to get a given optical absorption, and reducing the potential chemical toxicity of the pigment in the paint.

Methods of Making HUDS Micro-Particles

Once a large piece of HUDS is made via one of the above-described processes, it can be fractured (perhaps along naturally occurring non-HUDSian defect lines analogous to the grain boundaries in multi-crystalline silicon), ground, or otherwise divided into small particles which when sufficiently small can be dispersed into paints, inks, dyes, powders, or liquid plastics for use as a paint, ink, dye, or 3D printing material.

The structural color in the HUDS micro-particles arises from the structurally-induced wavelength-dependence of the optical reflectance R(λ) and transmittance T(λ) of the HUDS micro-particles as illustrated in FIG. 5, as well as from scattering effects (responsible for the colors of blue sky and of sunsets), and diffraction that arise when the particle size becomes sufficiently small to approach the wavelength of light. Because the HUDS are made of an artificial dielectric having optical properties which are angularly isotropic, they can exhibit precisely the same spectral reflectance R(λ) and transmittance T(λ) at all angles of incidence. That is, each spherical micro-particle of the same size will have precisely the same optical properties irrespective of the angle of either incident illumination or viewing direction. Methods for designing HUDS to exhibit photonic band gaps which are isotropic were described in Florescu, Torquato, and Steinhardt. “Designer disordered materials with large, complete photonic band gaps.” PNAS 106, no. 49, 20658-20663, 2009. The width and the center frequency of these photonic band gaps are design parameters depending on design factors which include the unit cell size, relative refractive index, and fill ratio. HUDS micro-particles designed to have photonic band gaps will also have angularly isotropic optical properties. These microspheres, non-spherical micro-particles, and paints containing HUDS micro-particles will therefore strongly reflect light across the designed frequency range corresponding to the gap in the photonic bands. Three-dimensional HUDS exhibit three-dimensional optical isotropy. Two-dimensional HUDS formed, e.g. in a finite-height plane, exhibit two-dimensional optical isotropy.

Under one approach, a starting point for manufacturing HUDS micro-particles is to divide large samples of HUDS into micro-particles or micro-flakes, preferably comprising 3D HUDS which exhibit 3D optical isotropy. A sheet of 2D finite height HUDS can also be used as the starting point to make micro-particles. In this case the micro-particles will have 2D optical isotropy.

In either case, a sheet, wafer, or other planar or solid structure comprising HUDS can be divided into micro-particles of HUDS or micro-flakes of HUDS.

The starting materials for these HUDS micro-particles can be fabricated by any technique including but not limited to the lithographic, self-assembly, and directed self-assembly techniques described above including e-beam lithography and reactive ion etching such as described in Nahal et al., 2013, optical lithography, self-assembly, directed self-assembly and other techniques described in this pattern or known to a person skilled in the art.

HUDS micro-particles having a relatively narrow reflection band will result from the above-described silica/resin system, because the very small index of refraction difference between the resin and the silica allows only a very small band of wavelengths to be reflected. Micro-particles having a substantially broader reflection band can be made, for example, from this same system by dissolving the silica away to leave a structure with the relevant index of refraction difference being between air (n=1) and the resin (n=1.4689). The dissolution of the silica can be done either before or after fracturing the HUDS into micro-particles.

Generally, common techniques known for making micro-particles comprising photonic crystals may be adapted to make micro-particles comprising HUDS. For example, large sheets of hyperuniform disordered structures fabricated by methods such as those described above can be divided into micro-particles or micro-flakes.

Under another technique, direct fabrication of micro-particles in micro-sphere or differently-shaped form factor is performed. The formation of >10 micron diameter micro-spheres comprising colloidal arrangements of nano-spheres has been demonstrated using a “droplet” process described by Kim et al. 2008, and Kim et al. 2006. The structure inside these micro-spheres varied from photonic crystal-like at the surface to substantially more disordered in the centers of the spheres. This team did not recognize that the disordered interiors could be made to exhibit a photonic band gap, without being crystalline, if only they were made to be hyperuniform.

One method for producing spheroidally-shaped micro-particles of photonic crystals by using small liquid droplets containing photo-polymerizable colloids was disclosed in Kim, Cho, et al. 2008. While these methods were reported (Yang, Kim and Shim, et al. 2008 priority) to have disadvantageously suffered from insufficient reflectivity due to their low crystallinity resulting from many defects present within the spheroidal space, the present invention does not require crystallinity.

Binders or Vehicles

Any number of common binders or vehicles can be used for dispersing the HUDS microparticles. For the lowest-transparency microparticles having optical properties resulting from the difference between the index of refraction of air and the material out of which the HUDS are made, the binder or vehicle must be chosen with appropriate concern to its “wettability” in a structure dimensioned on the half-wavelength scale of the HUDS micro-particle. Binders chosen not to “wet” structures having the characteristic half-wavelength average lattice spacing of HUDS advantageously allow the air voids in the HUDS micro-particles to remain air-filled rather than liquid-filled. Keeping the voids air-filled rather than liquid-filled advantageously preserves as large a refractive index difference as possible between the high-index material out of which the HUDS is made and the lower-index material that fills the voids in the HUDS. Alternatively, the micro-particles can be sealed with a transparent coating designed to transmit the relevant optical wavelengths while preventing the flow of liquid material into the voids of the HUDS micro-particle.

Tunability

The optical properties of the micro-particles, and hence the apparent color of a suspension or dispersion of them, can be tuned subsequent to fabrication via control of either the index of refraction of the comprising materials in the micro-particles, or via control of the size of the unit cells in the micro-particle. These factors can be controlled either via the process by which the HUDS emulsion is made, or subsequently.

Color-tuning can be either short-lasting or durable. For mixing paints which are loaded with micro-particles having structural color, it may be possible to make a wide range of paint or ink colors using a single (or very small number of) micro-particle design(s). This would prevent the need to stockpile a large number of different types of particles. Instead, the particles could be color-tuned on-the-spot, as needed to get the desired color in a paint comprising a suspension of micro-particles having structural color.

Tuning may involve one or more of the following techniques.

The index of refraction of the constituent materials can be tuned by any of several known methods, including known dependence of indices of refraction on temperature, optical power, electric field, electron density, magnetic field, etc.

Electric field tuning can be made particularly sensitive by incorporation of optically nonlinear materials. For example, the alignment of liquid crystals is sensitively controllable by application of an electric field. Liquid crystals are one class of a large number of highly polarizable atoms or molecules having indices of refraction that are sensitively dependent on electric field. The index of refraction of the other constituent materials may be tunable by injecting charge carriers, the density of which affects the material's index of refraction.

The index of refraction of the constituent material may also be temperature-tuned, either through the natural dependence of the material's index of refraction on temperature n(T) and/or through the way in which temperature-induced expansion of a material affects its optical properties via either temperature-induced changes in the local “fill ratio” and/or via temperature-induced changes in the average size of the HUDS unit cell. Temperature tuning can be either reversible or irreversible. Reversible temperature tuning would provide temperature-tuned color useful, for example, in applications such as color-coded thermometers. Irreversible temperature tuning may result, for example, from thermally-initiated chemical reactions capable of permanently “locking in” a changed index of refraction or volume for the material.

Carrier density: The index of refraction of the constituent material may be tunable by injecting charge carriers, the density of which affects the material's index of refraction. Carriers can be injected electrically (e.g. via electrodes or arc-discharge), or optically (as, for example, when the material is illuminated with photons having high enough energy to create an electron-hole pair in the material)

Optical fields: The index of refraction of the constituent material can be tuned by illuminating it with sufficiently high optical powers. In one embodiment, the higher-index component of HUDS may be silicon, in which carriers can be generated by illumination with radiation having energies greater than the electronic band gap of silicon. In another embodiment, one of the HUDS' comprising materials may be chosen for its sensitivity as a saturable absorber.

Other mechanisms for optically tuning the structural color of HUDS and HUDS micro-particles is optically-induced heating in an amount appropriate to temporarily change the size of the average HUDS unit cell.

Magnetic fields: The index of refraction of the constituent material may be magnetically tunable.

Methods to tune the structural color of HUDS subsequent to the initial formation of the structure include the following:

Irreversible tuning of structural color by application of an electric field is possible by choosing a material in which an electrical field drives an irreversible chemical reaction capable of permanently “locking in” a changed index of refraction or volume for the material. Microwave-fields, for examples, are known in the art to be effective initiators of chemical reactions.

Additional mechanisms for inducing long-lasting changes in both the optical index of refraction and “swelling” characteristics of polymers include materials that have been developed for application to optical holographic memories. These materials, if used as one of the two or more materials required to make HUDS, have absorption coefficients and indices of refraction which can be permanently altered by light, either globally across an entire HUDS structure or micro-particle, and/or locally at specific sites within a HUDS structure or micro-particle as may be beneficial in the event that one wants to create new defect states inside the particle having specially-engineered light-trapping properties. While the optically-induced change in index of refraction of polymer systems such as used by Sullivan, Grabowski and McLeod 2007 may be small (˜3×10⁴ on a background index of the fully-cured polymer of 1.481), larger optically-induced changes in index of refraction, as large as 0.1 were reported by McLeod and his colleague Mark Ayres from Akonia at the 2013 IEEE Photonics Conference in Bellevue, Wash.

As well, the structural color matrix can be designed to include resonant optical elements designed to resonantly absorb certain excitation frequencies. By designing these elements to comprise sufficiently absorptive and sufficiently fragile moieties, the system can be designed so that exposure of the structures to light at that particular frequency and at an appropriate intensity will be resonantly absorbed by the moiety, so as to either destroy it or permanently changing its optical properties

Other methods may also be used for dimensional (size) tuning. For example, any of multiple known methods for controlling the dimension of each unit cell may be employed, such as temperature-tuning, which can cause the expansion and contraction of the comprising materials, piezoelectric effects, which impart mechanical control of materials by application of electric fields, and other effects.

Acoustic fields may be useful for imparting either temporary or permanent color change to a previously-made element having structural color.

Temporary (reversible). An acoustic field propagating through a structural color system can distort the structure as it passes through the structure. Such distortions will change the photonic band gap and apparent color of the structure. Provided the acoustic field is not sufficiently strong to permanently change the structure, such changes will be temporary.

Permanent (irreversible). Very strong acoustic fields may impart sufficient energy to the matrix that portions of the matrix are permanently distorted, or even broken. Resulting changes in the photonic band gap may be permanent. The structure could be designed to have resonant elements particularly tuned to breaking when excited by particular sonic or ultrasonic frequencies.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A paint comprising a binder mixed with hyperuniformly disordered structures.

2. A method for chemical self-assembly of HUDS.

3. A method for making a paint comprising:
mixing a dispersion of hyperuniformly disordered structures throughout a binder.
